(19) United States
(12) Patent Application Publication
(10) Pub. No.: US 2008/0075166 A1
(43) Pub. Date: Mar. 27, 2008

(54) Unbiased Rounding for Video Compression

(75) Inventors: Walter Christian Gish, Oak Park, CA (US); Hyung-Suk Kim, Glendale, CA (US)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: Dolby Laboratories Licensing Corporation, San Francisco, CA (US)

(21) Appl. No.: 11/632,365

(22) PCT Filed: Jul. 12, 2005
(86) PCT No.: PCT/US05/24552

§ 371 Date: Apr. 12, 2007

Related U.S. Application Data
(60) Provisional application No. 60/587,699, filed on Jul. 13, 2004.

(51) Int. Cl. H04N 7/50

(52) U.S. Cl. 375/240.13; 375/240.12; 375/E07.211

(57) ABSTRACT

Unbiased rounding of unsigned data is employed in the decoding or the encoding and decoding of digital bitstreams representing data-video when the video is encoded at a first bit depth and is decoded at a second bit depth, lower than the first bit depth. The unbiased rounding may be employed in processing that employs a prediction loop. When the data-compressed video is represented in frames, the unbiased rounding may be of inter-frame and/or intra-frame data.

### TECHNICAL FIELD

This invention relates to digital methods for compressing moving images, and, in particular, to more accurate methods of rounding for compression techniques that utilize inter- or intra-prediction to increase compression efficiency. The invention includes not only methods but also corresponding computer program implementations and apparatus implementations.

### BACKGROUND ART

A digital representation of video images consists of spatial samples of image intensity and/or color quantized to some particular bit depth. The dominant value for this bit depth is 8 bits, which provides reasonable image quality and each sample fits perfectly into a single byte of digital memory. However, there is an increasing demand for systems that operate at higher bit depths, such as 10 and 12 bits per sample, as evidenced by the MPEG-4 Studio and N-bit profiles and the Fidelity Range Extensions to H.264 (see citations below).

Greater bit depths allow higher fidelity, or lower error, in the overall compression. The most common measure of error is the mean-squared error criterion, or MSE. The MSE between a test image whose spatial samples are test_{x,y} and a reference image whose spatial samples are ref_{x,y} is

$$M S E = \frac{1}{( NX ) ( NY )} {\sum }_{x}^{NX} {\sum }_{y}^{NY} {( {test}_{x , y} - {ref}_{x , y} )}^{2} \qquad ( 1 )$$

where NX and NY are the number of samples in the x- and y-directions. When the reference image is the input image and the test image is the compressed image, the MSE is called the distortion. In this case, the spatial samples of both these images are digital values. The fidelity of a compressed image is measured by this distortion or MSE, normalized to the maximum possible (peak) amplitude and measured in logarithmic units. In short, the distortion PSNR (Peak Signal-to-Noise Ratio) in dB is
PSNR=10 log(peak²/MSE) (2)

Greater bit depths permit higher values for PSNR. One can use the generality of the MSE criterion to show this. Consider the quantization of an analog input to N-bits. Here the MSE is computed between an analog input and its digital approximation. The quantization error for N-bit sampling is commonly modeled as independent, uniformly distributed random noise over the interval [−½, ½] so that the MSE is 1/12 with respect to the least significant bit. Since the input samples are integers in the range [0, 2^{N}−1], the peak value is 2^{N}−1. Thus the PSNR corresponding to this MSE is
PSNR=10 log((2^{N}−1)²/( 1/12)) (3)

Since this represents the error between the analog samples of the original image and its quantized representation, it is an upper bound for the fidelity of the compressed result compared to the original analog image. Table 1 shows this upper bound for some representative bit depths:

TABLE 1
Maximum PSNR as a function of bit depth

| bit depth | PSNR limit (dB) |
|---|---|
| (bits) | (due to round-off) |
| 8 | 58.92 |
| 10 | 70.99 |
| 12 | 83.04 |
| 14 | 95.08 |
| 16 | 107.12 |

FIG. 1 and FIG. 2 show block diagrams for an H.264 encoder and decoder, respectively. H.264, also known as MPEG-4/AVC, is considered the state-of-the-art in modern video coding. Of particular relevance here are a set of extensions currently being developed for H.264 known collectively as the “Fidelity Range Extensions.”

Aspects of the present invention may be used with particular advantage in “H.264 FRExt” coding environments. Details of H.264 coding are set forth in “Draft ITU-T Recommendation and Final Draft International Standard of Joint Video Specification (ITU-T Rec. H.264|ISO/IEC 14496-10 AVC),” Joint Video Team (JVT) of ISO/IEC MPEG & ITU-T VCEG (ISO/IEC JTC1/SC29/WG11 and ITU-T SG16 Q.6), 8^{th} Meeting: Geneva, Switzerland, 23-27 May, 2003. Details of the “Fidelity Range Extensions” to the basic H.264 specifications (hence “H.264 FRExt”) are set forth in “Draft Text of H.264/AVC Fidelity Range Extensions Amendment,” Joint Video Team (JVT) of ISO/IEC MPEG & ITU-T VCEG (ISO/IEC JTC1/SC29/WG11 and ITU-T SG16 Q.6), 11^{th} Meeting: Munich, DE, 15-19 Mar., 2004. Both of the just-identified documents are hereby incorporated by reference in their entireties. The “Fidelity Range Extensions” will support higher-fidelity video coding by supporting increased sample accuracy, including 10-bit and 12-bit coding. Aspects of the present invention are particularly useful in connection with the implementation of such increased sample accuracy. Further details regarding the H.264 standard and its implementation may be found in various published literature, including, for example, “The emerging H.264/AVC standard,” by Ralf Schäfer et al, EBU Technical Review, January 2003 (12 pages) and “H.264/MPEG-4 Part 10 White Paper: Overview of H.264,” by lain E G Richardson, Jul. 10, 2002, published at www.vcodex.com. Said Schafer et al and Richardson publications are also incorporated by reference herein in their entirety. Aspects of the present invention may also be used with advantage in connection with modified MPEG-2 coding environments, as is explained further below.

An H.264 or H.264 FRExt encoder (they are the same at a block diagram level) shown in FIG. 1 has elements now common in video coders: transform and quantization processes, entropy (lossless) coding, motion estimation (ME) and motion compensation (MC), and a buffer to store reconstructed frames. H.264 and H.264 FRExt differ from previous codecs in a number of ways: an in-loop deblocking filter, several modes for intra-prediction, a new integer transform, two modes of entropy coding (variable length coding and arithmetic coding), motion block sizes down to 4×4 pixels, and so on.

Except for the entropy decode step, the H.264 or H.264 FRExt decoder shown in FIG. 2 can be readily seen as a subset of the encoder.

The Fidelity Range Extensions (FRExt) to H.264 provide tools for encoding and decoding at sample bit depths up to 12 bits per sample. This is the first video codec to incorporate tools for encoding and decoding at bit depths greater than 8 bits per sample in a unified way. In particular, the quantization method adopted in the Fidelity Range Extensions to H.264 produces a compressed bit stream that is potentially compatible among different sample bit depths as described in copending U.S. provisional patent application Ser. No. 60/573,017 of Walter C. Gish and Christopher J. Vogt, filed May 19, 2004, entitled “Quantization Control for Variable Bit Depth” and in the U.S. non-provisional patent application Ser. No. 11/128,125, filed May 11, 2005, of the same inventors and bearing the same title, which non-provisional application claims priority of said Ser. No. 60/573,017 provisional application. Both said provisional and non-provisional applications of Gish and Vogt are hereby incorporated by reference in their entirety. The techniques of said provisional and non-provisional patent applications facilitate the interoperability of encoders and decoders operating at different bit depths, particularly the case of a decoder operating at a lower bit depth than the bit depth of an encoder. Some details of the techniques disclosed in said non-provisional and provisional applications of Gish and Vogt are published in a document that describes the quantization method adopted in the Fidelity Range Extensions to H.264: “Extended Sample Depth: Implementation and Characterization,” Joint Video Team (JVT) of ISO/IEC MPEG & ITU-T VCEG (ISO?IEC JTC1/SC29/WG11 and ITU-T SG16 Q.6), Document JVT-H016, 8^{th} Meeting: Geneva, Switzerland, 23-27-May, 2003, published on the world wide web at http://ftp3.itu.ch/av-arch/jvt-site/2003_{—}05_Geneva/JVT-H016.doc. Said JVT-H016 document is also hereby incorporated by reference in its entirety.

A goal of the present invention is to be able to decode a bitstream encoded at a high bit depth from a high bit depth input not only at that same high bit depth, but, alternatively, at a lower bit depth that provides decoded images bearing a reasonable approximation to the original high bit depth images. This would, for example, enable an 8-bit or 10-bit H.264 FRExt decoder to reasonably decode bitstreams that would conventionally require, respectively, a 10-bit or 12-bit H.264 FRExt decoder. Alternatively, this would enable a conventional 8-bit MPEG-2 decoder (as in FIG. 9 described below) to reasonably decode bitstreams produced by a modified MPEG-2 encoder such as described below in connection with FIG. 10a, which decoding would otherwise require the modified MPEG-2 decoder such as described below in connection with FIG. 10b.

FIG. 3 shows that when a single bitstream encoded from a high bit depth source is decoded at the original high bit depth and at a lower bit depth, the lower bit depth decoding has some error, measured as MSE, with respect to the high bit depth reference. In the example of FIG. 3, the lower bit depth approximation is decoded as if the encoder bit depth were low, that is, it is a conventional decoder (see FIG. 6 below) or a conventional decoder employing the unbiased rounding aspects of the present invention (see FIG. 7 below).

While one would expect the decoded results at different bit depths to differ somewhat due to rounding error, the actual differences observed with prior art encoders and decoders tend to be much larger. Such large differences occur because the rounding errors will accumulate from prediction to prediction in a manner that is exacerbated by the way rounding is currently done. FIG. 4 shows a simplified diagram of the prediction loop that exists in both the encoder and decoder identifying the places where rounding occurs: calculating the prediction (intra and inter), the deblocking filter, and the residual decoding. One can see how errors will accumulate from prediction to prediction in the feedback loop formed by the Frame Store, Prediction, the adder, and the Deblocking Filter. As explained further below, the dominant sources of error are inter- and intra-prediction. The loop deblocking filter is optional and, along with the rounding in decoding, the residual will introduce smaller errors. The problem then is to minimize these errors so that the MSE between the high bit depth output and the lower bit depth approximation is minimized. The high bit depth decoding output is error free with respect to the encoder since they both have the same high bit depth prediction loop. Therefore, a reduction in the MSE between it and the lower bit depth approximation indicates that the lower bit depth decoding more closely approximates the high bit depth decoding.

For the case of inter-prediction, rounded results from one frame are used to predict the image in another frame. Consequently, the error grows over successive frames because the feedback loop comprised of the frame store (buffer) and the prediction from the motion compensation filter accumulates errors. The result is that the MSE between the decoded frames of different bit depths shown in FIG. 3 increases at each predicted frame or macroblock. In the prior art such error that accumulates from frame to frame was first encountered in dealing with the allowable mismatch between IDCTs in MPEG-2. Because the error would grow from frame to frame it was called “drift.” The intra-prediction modes in H.264 behave similarly; only in this case the rounded results for pixels are used to predict other neighboring pixels in the same frame. Both intra- and inter-prediction are identical in that the error accumulates from prediction to prediction and the form of the prediction calculations is the same. In both cases, the prediction is the rounded sum of integer values from the frame store weighted by fractional coefficients whose sum is 1. That is, the predicted value pred(xy) is

$$pred ( x , y ) = {\sum }_{i , j} c ( i , j ) F S ( {x}^{′} , {y}^{′} ) + 1 / 2 \\ {\sum }_{i , j} c ( i , j ) = 1 \qquad ( 4 )$$

where FS(x′,y′) are Frame Store values and c(i,j) are the weighting coefficients. The relationship between (x,y), (x′,y′), and (i,j) and the values for c(ij) depend on the type of predictor: inter or a particular intra mode. Because the coefficients c(i,j) are fractional values, this calculation is typically performed using integer coefficients C(i,j) that sum to a power of two with a final right-shift to truncate the result to the final bit depth.

$$pred ( x , y ) = [ {\sum }_{i , j} C ( i , j ) F S ( {x}^{′} , {y}^{′} ) + {2}^{M - 1} ] >> M \\ {\sum }_{i , j} C ( i , j ) = {2}^{M} \qquad ( 5 )$$

In this form, the number of fractional bits rounded away is M, so that the added ½ for rounding is scaled to 2^{M-1}. This form is important not just because it is the most common form actually used, but because the value of M determines the severity of the rounding error (i.e., equation 9).

It is desirable that systems using different sample bit depths are as interoperable as possible. That is, one would like to be able to decode reasonably a bitstream regardless of the bit depth of the encoder or decoder. When the decoder has a bit depth equal to or larger than the bit depth of the input, it is trivial to mimic a decoder with the same bit depth as the encoder. When the decoder has a bit depth less than the encoder, there must be some loss, but the decoded results should have a PSNR appropriate for that lower bit depth, and, desirably, not less. Achieving interoperability between different bit depths requires careful attention to arithmetic details. United States Patent Application Publication US 2002/0154693 A1 disclosed a method for improving coding accuracy and efficiency by performing all intermediate calculations with greater precision. Said published application is hereby incorporated by reference in its entirety. In general, reasonable and common approximations at a lower bit depth can become unacceptable when compared to calculations at a higher bit depth. An aspect of the present invention is directed to a method for improving the rounding in such intermediate calculations in order to minimize the error when decoding a bitstream at a lower bit depth than the input to the encoder.

### DISCLOSURE OF THE INVENTION

In one aspect, the present invention is directed to the reduction or minimization of the errors resulting from decoding at a lower bit depth a video bitstream that was encoded at a higher bit depth compared to decoding such a bitstream at the higher bit depth. In particular, it is shown that a major, if not the dominant, contribution to such errors is the simple, but biased, rounding that is used in prior art compression schemes. In accordance with an aspect of the present invention, unbiased rounding methods in the decoder, or, as may be appropriate, in both the decoder and the encoder, are employed to improve the overall accuracy resulting from decoding at lower bit depths than the bit depth of the encoder. Such results may be demonstrated by the reduction or minimization of the error between the decoded results at a bit depth that is the same as the bit depth of the encoder and at a lower bit depth. Other aspects of the invention may be appreciated as this document is read and understood.

### DESCRIPTION OF THE DRAWINGS

FIG. 1 is a schematic functional block diagram of an H.264 or H.264 FRExt video encoder.

FIG. 2 is a schematic functional block diagram of an H.264 or H.264 FRExt video decoder.

FIG. 3 is a schematic functional block diagram of an arrangement for comparing the quality of the outputs of two decoders.

FIG. 4 is a schematic functional block diagram of the prediction loop in an encoder and a decoder, identifying the places where rounding occurs.

FIG. 5 is a schematic functional block diagram of a motion compensation feedback loop (the deblocking filter and adder for the coded residual shown in FIG. 4 have been removed for simplicity).

FIG. 6 is a graphical representation showing the number of cumulative errors (vertical scale) versus video frame number (horizontal scale) for the case of a conventional decoder operating at a lower bit depth than the bit depth of the encoder with respect to a reference decoder (a decoder operating at the bit depth of the encoder).

FIG. 7 is a graphical representation showing the number of cumulative errors (vertical scale) versus video frame number (horizontal scale) for the case of a conventional decoder employing unbiased rounding operating at a lower bit depth than the bit depth of the encoder with respect to a reference decoder (a decoder operating at the bit depth of the encoder).

FIG. 8 is a representation of pixels in consecutive video lines, showing the pixels (unshaded) that may be used to predict another pixel (shaded).

FIG. 9 is a schematic functional block diagram showing a prior art MPEG-2 encoder (FIG. 9a) and decoder (FIG. 9b).

FIG. 10 is a schematic functional block diagram of a modified MPEG-2 encoder (FIG. 10a) and decoder (FIG. 10b).

FIG. 11 is a comparison of 8-bit and 10-bit versions of the input, residual, transformed residual, and quantized transformed residual in MPEG-2 type devices.

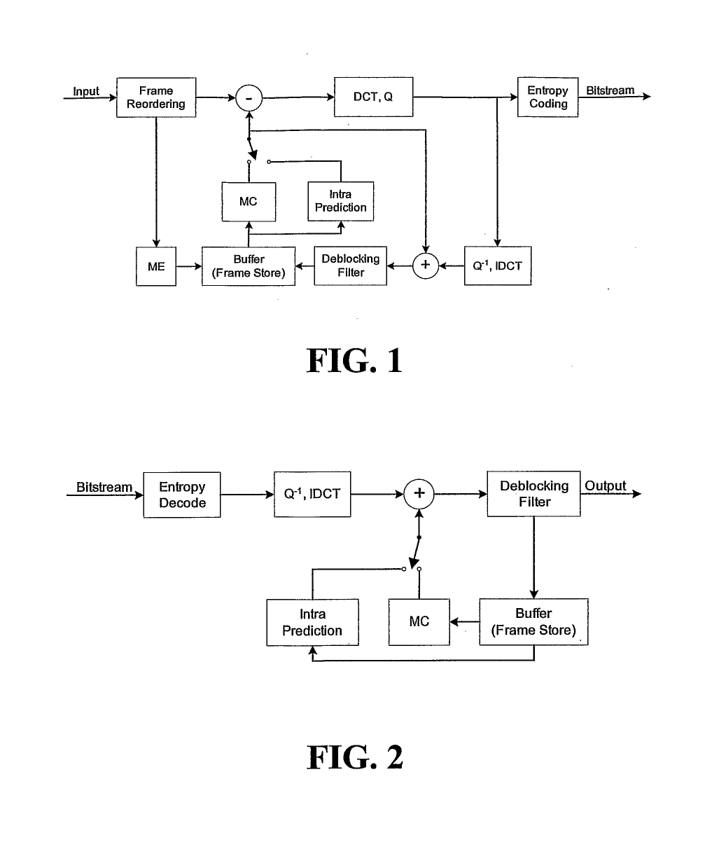

### BEST MODE FOR CARRYING OUT THE INVENTION

### Fundamentals of Biased and Unbiased Rounding

Aspects of the present invention propose the use of unbiased rounding in the decoder, or, as may be appropriate, in both the encoder and decoder, for video compression, particularly for inter- and intra-prediction, where the error tends to accumulate in the prediction loop. Thus, one may begin with an analysis of rounding methods and the errors they introduce. In particular, the mean and variance of the error caused by rounding are of interest. Because the calculations in video compression are typically performed with integers of different precision, the rounding of integers is of particular interest.

The most commonly employed rounding method adds ½ and then truncates the result. That is, given a (N+M)-bit value s where the binary point is between the N and M-bit portions, a rounded N-bit value r is given by
r=s+½ (6)

where the equal sign implies truncation. Let's suppose that M is 2. In this case there are four possibilities for the M fractional bits in s:

TABLE 2
Biased rounding

| Fractional bits in s | s + ½ | r | Error (s − r) |
|---|---|---|---|
| .00 | .10 | — | 0 |
| .01 | .11 | — | +.01 (+¼) |
| .10 | 1.00 | +1 | −.10 (−½) |
| .11 | 1.01 | +1 | −.01 (−¼) |

That is, for 0.00 and 0.01, one rounds down and, for 0.10 and 0.11, one rounds up. The problem occurs for the ½ value for the fractional bits in s, which in this example is the 0.10 case. It is known (for example, in the field of numerical analysis) that rounding the ½ value requires special treatment. This is, although the 0.01 and 0.11 cases balance each other, there is nothing to balance the 0.10 case. This imbalance causes the mean error to be non-zero.

Because each of these four cases is equally probable, the error mean and variance are

$$m = \frac{1}{4} ( 0 + \frac{1}{4} - \frac{1}{2} - \frac{1}{4} ) = - \frac{1}{8} \\ {σ}^{2} = \frac{1}{4} ( 0 + \frac{1}{16} + \frac{1}{4} + \frac{1}{16} ) = \frac{3}{32} \qquad ( 7 )$$

The error variance, 3/32, is close to the variance for the continuous case, 1/12. Because the error mean is non-zero, this is called, “biased rounding.” There is little that can be done to reduce the error variance as a non-zero error variance is unavoidable with rounding. However, there are known solutions for reducing the mean error to zero. When the fraction is exactly ½, all of these solutions round up half the time and round down half the time. The decision to round up or down can be made in a number of ways, both deterministically and randomly. For example:
(a) Round to even: if the integer portion of s is odd round r up, otherwise down
(b) Alternate: a one bit counter is incremented at each rounding, if the counter is 1 round up, otherwise, round down
(c) Random: pick a random number in [0,1], if this number is greater than ½, round up, otherwise round down

With these methods, the possible outcomes shown in Table 2 become:

TABLE 3
Unbiased rounding

| Fractional bits in s | Probability | s + ½ | r | Error (s − r) |
|---|---|---|---|---|
| .00 | ¼ | .10 | — | 0 |
| .01 | ¼ | .11 | — | +.01 (+¼) |
| .10 | ⅛ | 1.00 | — | +.10 (+½) |
| .10 | ⅛ | 1.00 | +1 | −.10 (−½) |
| .11 | ¼ | 1.01 | +1 | −.01 (−¼) |

So that the mean error and variance are

$$m = \frac{1}{4} ( 0 + \frac{1}{4} - \frac{1}{4} ) + \frac{1}{8} ( \frac{1}{2} - \frac{1}{2} ) = 0 \\ {σ}^{2} = \frac{1}{4} ( 0 + \frac{1}{16} + \frac{1}{16} ) + \frac{1}{8} ( \frac{1}{4} + \frac{1}{4} ) = \frac{3}{32} \qquad ( 8 )$$

Since this reduces the mean error to zero, it is called unbiased rounding.

While this is generally how the term unbiased rounding is used, there are known examples where the term is used differently. By unbiased rounding is meant rounding with special attention to the ½ value for the fractional portion so that it is rounded up and down with equal frequency. An example of prior art that uses the term unbiased rounding in the same way is published U.S. Patent Application 2003/0055860 A1 by Giacalone et al entitled “Rounding Mechanisms in Processors”. This application describes circuitry for the implementation of the “round to even” form of unbiased rounding when rounding 32-bit integers to 16-bits. On the other hand, U.S. Pat. No. 5,930,159 by Wong entitled “Right-Shifting an Integer Operand and Rounding a Fractional Intermediate Result to Obtain a Rounded Integer Result” describes what it characterizes as “unbiased” methods for “rounding” towards zero or towards infinity as described in the MPEG-1 and MPEG-2 standards. However, the methods Wong describes are more appropriately viewed as truncation methods rather than rounding. Furthermore, they are unbiased only for an equal mix of positive and negative values; they are highly biased (as all truncation methods are) for non-negative values. Unbiased rounding, as used herein, is unbiased for positive and negative values separately and not just in combination.

The magnitude of the error introduced by biased rounding depends on the number of fractional bits, M. In the example presented above, M is 2 and so the case that causes the bias occurs 25% of the time. If M is 1, this case occurs 50% of the time and so the mean error is twice as large. Analogously, if M is 3, this case occurs 12.5% of the time and so the mean error is half as much. Thus, in general, the mean error for biased rounding is

$$m = - \frac{1}{{2}^{M + 1}} \qquad ( 9 )$$

This result is somewhat counter-intuitive in that it shows that the mean error introduced by biased rounding is larger for less (i.e., smaller M) rounding.

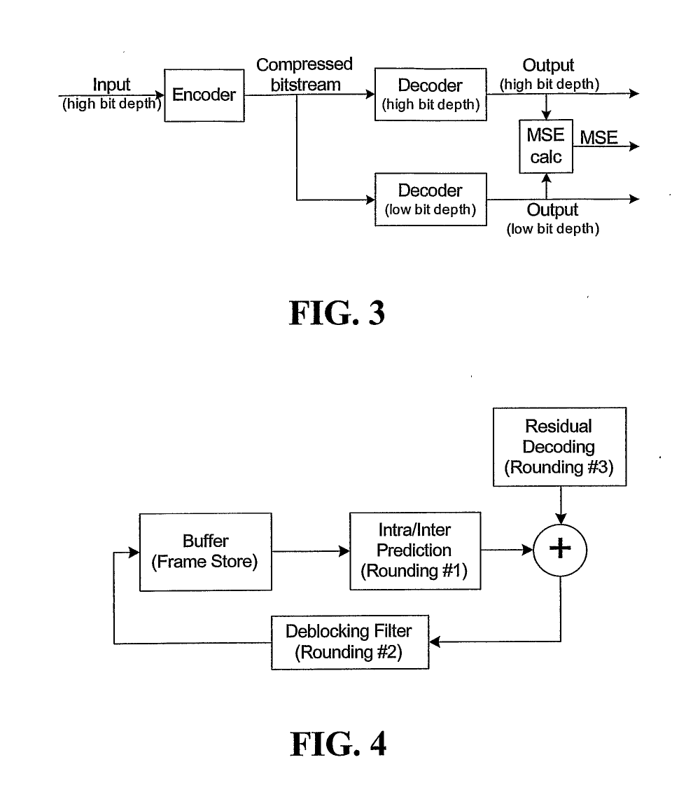

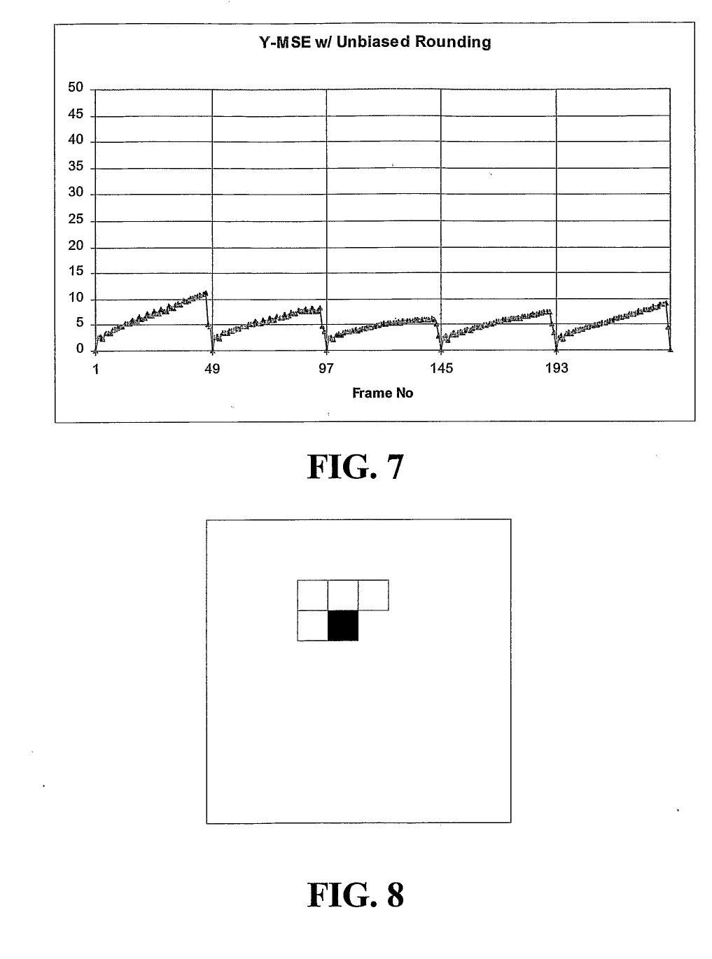

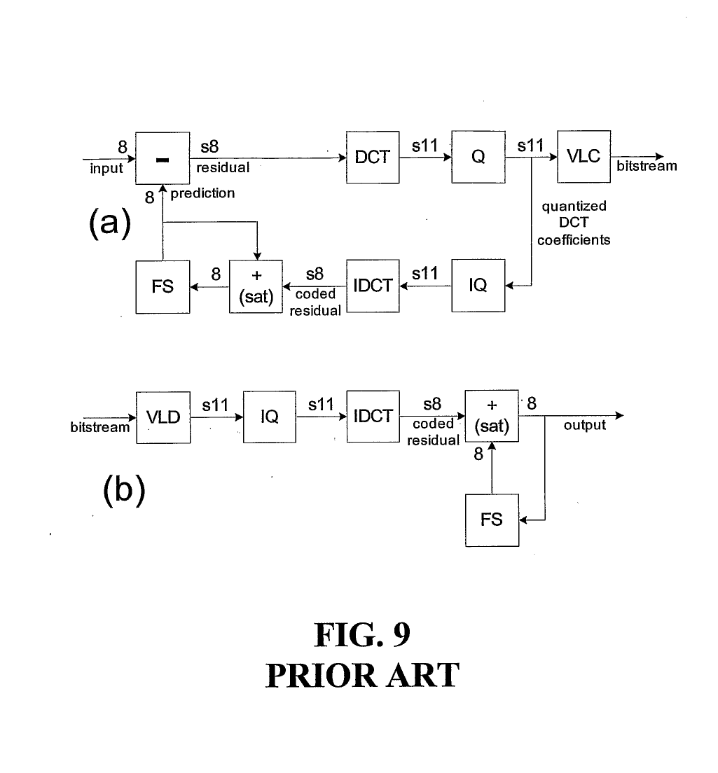

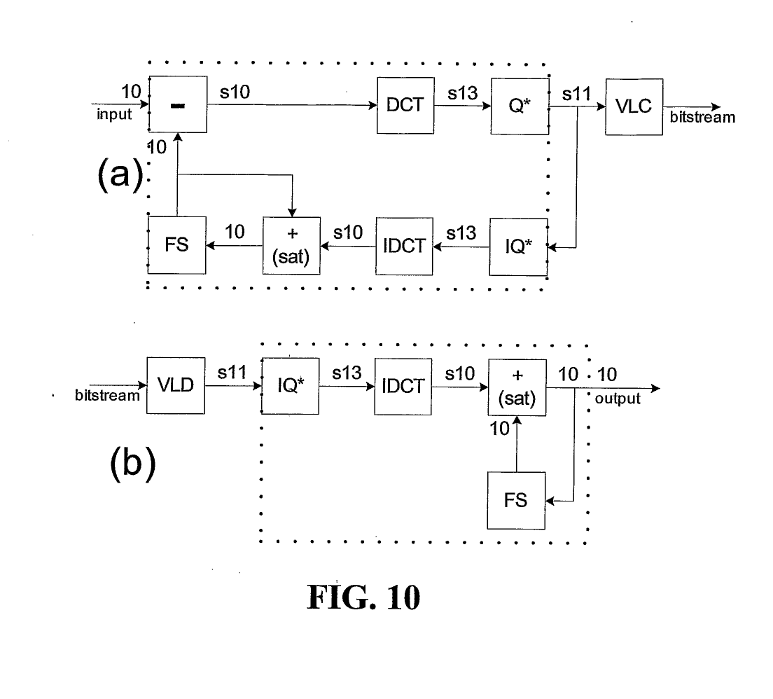

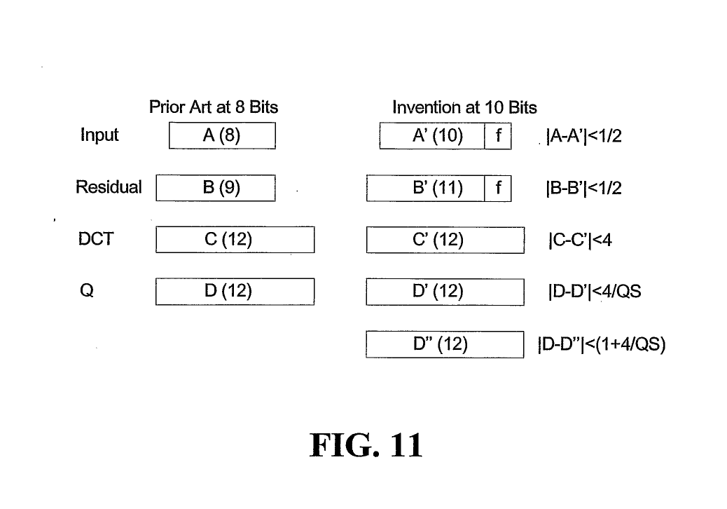

For the tests whose results are shown in FIG. 6 and FIG. 7, 10-bit per sample video is encoded at 10 bits using a modified MPEG-2 encoder as described in connection with FIG. 10a and then decoded in three ways: (1) a 10-bit decoding using a modified MPEG-2 decoder, as described in connection with FIG. 10b (this decoding is used as a reference for the two eight-bit decodings next described, in the manner of the FIG. 3 test arrangement), (2) an 8 bit decoding using a conventional MPEG-2 8-bit decoder, as described in connection with FIG. 9b, and (3) an 8 bit decoding using an otherwise-conventional MPEG-2 8-bit decoder (as in FIG. 9b) but which is modified to employ unbiased rounding in accordance with aspects of the present invention. The MSE for the 8-bit decoder without unbiased rounding and for the 8-bit decoder with unbiased rounding are each computed with reference to the 10 bit decoding in the manner as shown in FIG. 3. To bound the overall drift MSE, an I-frame is inserted by the modified MPEG-2 encoder every 48 frames. Comparing FIGS. 6 and 7 shows that unbiased rounding reduces the MSE by about a factor of four (75% reduction). Furthermore, the slightly quadratic growth in MSE (i.e., a positive second derivative) of FIG. 6 is replaced in FIG. 7 with a growth rate that is linear or even sub-linear. This is entirely due to using unbiased rounding to reduce to zero the mean error, the dominant (i.e., quadratic) term in equation (12) and (13).

### Effect of Unbiased Rounding on Inter-Prediction (Motion Compensation)

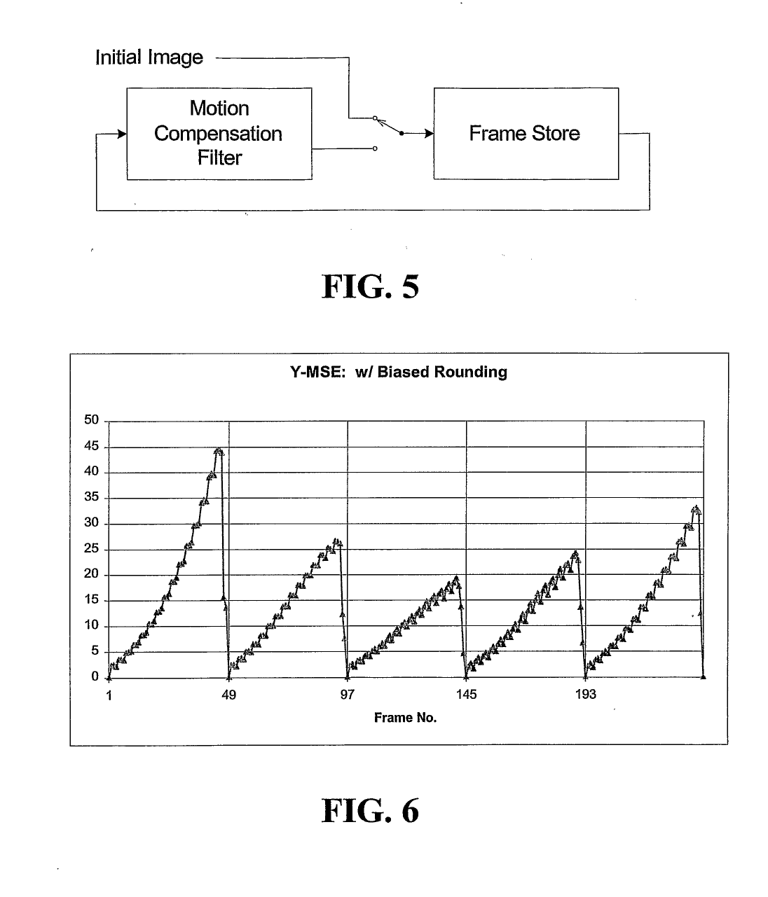

In general, unbiased rounding is superior to biased rounding because the mean error is reduced to zero while the variance remains unchanged. We will show that the effects of biased rounding are particularly detrimental in motion compensation because the feedback loop causes error to accumulate. FIG. 5 shows the essential components of such a motion compensation feedback loop (the deblocking filter and adder for the coded residual shown in FIG. 4 have been removed for simplicity).

The frame store in FIG. 5 is initialized by some initial image. In common practice, this initial image corresponds to an intra-macroblock or intra-frame picture. The motion compensation filter interpolates a portion of the frame store displaced by the integer portion of a motion vector. This filter has the overall linear form shown in equations (4) and (5). The filter coefficients themselves are generally a windowed sinc function with a phase determined by the fractional portion of the motion vector, and (x′,y′) is determined by the integer portion of the motion vector. Round-off error is unavoidable given the fractional coefficients c(i,j) or their integer version C(i,j). Only in the case that c(i,j) were an integer would there be no round-off error.

Because of the feedback loop in FIG. 5, the error variance adds incoherently from iteration to iteration, but the mean error adds coherently so that the mean error eventually dominates the total mean-squared error (MSE) in the frame store. Table 4 (below) tabulates the relative contributions of the mean error and variance error to the overall MSE from iteration to iteration. Each iteration corresponds to the next P-frame or P-macroblock, i.e., one that is predicted from a previous frame or macroblock. When B-frames are used as reference frames, they also constitute an iteration. At the Kth iteration the cumulative mean error is

$$m = K ( - \frac{1}{8} ) \qquad ( 10 )$$

the cumulative variance error is

$${σ}^{2} = K ( \frac{3}{32} ) \qquad ( 11 )$$

and the resulting MSE is given by the well-known formula
MSE=m²+σ² (12)
which, for the case of M=2 (two bits of rounding), exemplified by equations (10) and (11), becomes

$$M S E = \frac{1}{64} {K}^{2} + \frac{3}{32} K \qquad ( 13 )$$

These equations show biased rounding is the asymptotically dominant (i.e., quadratic in K) contributor to the overall MSE.

TABLE 4
Error growth in the prediction loop

| | Total mean | MSE from mean | MSE from variance |
|---|---|---|---|
| Iteration | error | error | error |
| 1 | −⅛ | 1/64 | 3/32 |
| 2 | −¼ | 1/16 | 3/16 |
| 3 | −⅜ | 9/64 | 9/32 |
| 4 | −½ | ¼ | ⅜ |
| . . . | . . . | . . . | . . . |
| 6 | −¾ | 9/16 | 9/16 |
| . . . | . . . | . . . | . . . |
| 8 | 1 | 1 | ¾ |
| . . . | . . . | . . . | . . . |
| 16 | 2 | 4 | 3/2 |
| . . . | . . . | . . . | . . . |
| 32 | 4 | 16 | 3 |

Examining Table 4, one can see that initially the contribution from the mean error is ⅙ the contribution from the variance error. However, they are equal at the sixth iteration, and by the 32^{nd} iteration the mean error is over 5 times the variance error.

Because the actual filtering in motion compensation is 2-dimensional, and the number of fractional bits rounded depends on codec-specific details, the foregoing examples are only illustrative. The iteration, where the mean error dominates, can vary from this simple example, but regardless of the details, the mean error dominates after a small number of iterations.

By changing to unbiased rounding the contribution from mean error can be reduced to zero. FIG. 6 and FIG. 7 show the growth of the MSE or drift error with biased rounding as in the prior art and unbiased rounding in accordance with the present invention, respectively, for decoding at 8-bits a bitstream encoded from a 10-bit source using the modified version of MPEG-2 shown in FIG. 10(a).

### Effect of Unbiased Rounding on Intra-Prediction

H.264 and H.264 FRExt are unique among modern codecs in that they have many modes for intra-prediction. Most of these modes average a number of neighboring pixels (most commonly two or four) to arrive at an initial estimate for the given pixel. These averaging calculations have the same linear form shown in equations 4 and 5 with biased rounding. Because only a small number of values are combined, the error from biased rounding is particularly significant since this corresponds to M=1,2 in Equation 6.

FIG. 8 shows the blocks (in white) that can influence the intra-predicted values for a given block (in black) in the H.264 and H.264 FRExt systems. Because these predictions can take place on blocks as small as 4×4 pixels, the error propagation for intra-prediction can occur over and over many times. For example, at the HDTV resolution of 1080×1920, there can be hundreds of iterations in both the horizontal and vertical directions. By comparison, the error propagation for inter-prediction shown in FIG. 6 and FIG. 7 was only for 16 iterations, and Table 4 only went up to 32 iterations.

When one attempts to use a conventional 8-bit H.264 FRExt decoder to decode a bitstream generated by a 10-bit FRExt encoder the resultant images are recognizable but the colors are different. Even the very first I frame illustrates this because of rounding errors in intra-prediction. Furthermore, if one subtracts the 8-bit decoded image from the reference 10-bit decoded image, the error can be seen to propagate down and to the right as FIG. 8 suggests. Because the error for intra-prediction grows in a complex fashion over the two-dimensional image there is no simple plot of increasing error analogous to FIG. 6 and FIG. 7. However, the effects of unbiased rounded are the same. For example, unbiased rounding can reduce the MSE for the initial I-frame (which has only intra-prediction) from a low PSNR of around 20 dB, to a high PSNR close to 50 dB.

Video compression techniques, such as MPEG-2, are widely deployed today. FIGS. 9a and 9b, respectively, show prior art implementations of an MPEG-2 encoder and decoder (b). In most commonly-used MPEG-2 video compression configurations, called profiles, video data having an input precision, or bit depth, of 8 bits is applied. This input precision subsequently determines the minimum precision of various internal variables used in compression. Thus, typically, input video with a precision, or bit depth, of 8 bits is applied to a subtractor (“−”). The integer output of the subtractor also has 8 bits of precision, but since it can be negative, it requires a sign bit for a total of 9 bits which is shown as “s8” (signed 8). The difference output of the subtractor is called the “residual.” This integer output is then applied to a 2-D DCT whose output requires three additional bits or 12 bits in a signed 11 bit (“s11”) format. These 12 bits are quantized and then entropy (variable length coding) (“VLC”) coded with other parameters to produce an encoded bitstream. The quantized, transformed coefficients are also inverse quantized (“IQ”), inverse transformed (“IDCT”), and added (with saturation) to the same prediction used in the original subtraction. Note that this portion of the encoder mimics the decoder shown in FIG. 9b. Because the entropy coding (“VLC”) and decoding (“VLD”) are lossless, the quantized DCT coefficients input to the VLC are identical to those output from the VLD block. If the IDCTs in the decoder and encoder are identical, the decoded residual in the encoder and decoder are identical. The decoded residual is an approximation to the raw residual. By adding this decoded residual to the prediction and saturating to the original range ([0,255] for MPEG-2), one creates a decoded frame that is an approximation of the input frame. Such decoded frames are stored in a frame store (“FS”) whose contents are the same (within IDCT error tolerances) in the encoder and decoder. The decoded frames are then used for creating a prediction to use in the original subtraction. Thus, in summary, a prior art MPEG-2 system has bit-depth precisions of

| | | |
|---|---|---|
| Input | 8 | bits (unsigned) |
| Frame store (for prediction) | 8 | bits (unsigned) |
| Residual (input minus prediction) | 9 | bits (signed) |
| Transformed residual | 12 | bits (signed) |
| Quantized data | 12 | bits (signed) |

In the MPEG-2 modifications shown in FIGS. 10a and 10b, video sequences are encoded at a higher precision than in conventional MPEG-2 while maintaining compatibility with nominal 8-bit streams. This is achieved by increasing the precision used to perform calculations so as to make optimal use of the precision carried by the transformed and quantized residuals. This is particularly applicable to MPEG-2, which uses 12 bits for the transformed and quantized residuals while the input video is only 8 bits.

In the modifications of FIGS. 10 and 10b, the precision of all internal encoder and decoder calculations is increased by two bits, the input source has a bit depth that is two bits greater, and the quantized data precision remains the same, that is:

| | |
|---|---|
| Input | 10 bits (unsigned) |
| Frame store (for prediction) | 10 bits (unsigned) |
| Residual (input minus prediction) | 11 bits (signed) |
| Transformed residual | 14 bits (signed) |
| Quantized data | 12 bits (signed) |

Those portions of the encoder and decoder that are altered are enclosed by a dotted line in each of FIGS. 10a and 10b.

In addition, the quantization and inverse quantization (indicated by the *) are altered so that the scale of the quantized values does not change. Since the internal variables in the 10-bit encoder have two extra bits of precision, this change is an additional right shift of 2, or a division by 4, for quantization and an additional left shift of 2, or a multiplication by 4, for dequantization. Since 8-bit quantization is simply a division by the quantization scale, QS, the equivalent 10-bit quantization is simply a division by four times the quantization scale, or 4*QS. Similarly, since inverse quantization at 8-bits is basically a multiplication by the quantization scale QS, at 10-bits we simply multiply by four times the quantization scale. Thus the changes required for Q* and IQ* are simply to alter the quantization scale, QS, according to the bit depth.

Another modification of MPEG-2 encoders and decoders is described in International Publication Number WO 03/063491 A2, “Improved Compression Techniques,” by Cotton and Knee of Snell & Wilcox Limited. According to the Cotton and Knee publication, the calculation precision in a video compression encoder and decoder are increased except for the precision of the frame store. Such an arrangement may also be useful for encoding when unbiased rounding is employed in an otherwise-conventional MPEG-2 decoder.

### SUMMARY

Unbiased rounding has a significant effect on the error between high and low bit depth decoding of the same bitstream. Biased rounding creates both a mean and variance error. The mean error is coherent, grows rapidly (MSE growth is quadratic in K as shown by equations (12) and (13)) from prediction to prediction, and is quite visible. The variance error grows more slowly (MSE growth is linear) and is much less visible because it is random and has lower amplitude. Unbiased rounding is more accurate when rounding is required. In accordance with aspects of the present invention, in order to make lower bit depth calculations closer to the same calculations at a higher bit depth, unbiased rounding may be applied to calculations in the prediction loop, particularly inter- and intra-prediction.

### Implementation

The invention may be implemented in hardware or software, or a combination of both (e.g., programmable logic arrays). Unless otherwise specified, the algorithms included as part of the invention are not inherently related to any particular computer or other apparatus. In particular, various general-purpose machines may be used with programs written in accordance with the teachings herein, or it may be more convenient to construct more specialized apparatus (e.g., integrated circuits) to perform the required method steps. Thus, the invention may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the invention have been described. Nevertheless, it will be understood that various modifications may be made without departing from the spirit and scope of the invention.

1. A method for decoding a digital bitstream representing data-compressed video encoded at a first bit depth, comprising
decoding at a second, lower, bit depth, said decoding including the unbiased rounding of unsigned data in intermediate processing.

2. A method according to claim 1 wherein the decoding includes processing in a prediction loop and said processing includes said unbiased rounding of unsigned data.

3. A method according to claim 1 or claim 2 wherein the data-compressed video is represented in frames and said unbiased rounding of unsigned data includes the unbiased rounding of inter-frame and/or intra-frame data.

4. A method for encoding a digital bitstream representing data-compressed video, wherein the encoding includes the unbiased rounding of unsigned data in intermediate processing.

5. A method according to claim 4 wherein the encoding includes processing in a prediction loop and said processing includes said unbiased rounding of unsigned data.

6. A method according to claim 4 or claim 5 wherein the data-compressed video is represented in frames and said unbiased rounding of unsigned data includes the unbiased rounding of inter-frame and/or intra-frame data.

7. A method for encoding and decoding a digital bitstream representing data-compressed video, comprising
encoding at a first bit depth, said encoding including the unbiased rounding of unsigned data in intermediate processing, and
decoding at a second, lower, bit depth, said decoding including the unbiased rounding of unsigned data in intermediate processing.

8. A method according to claim 7 the encoding includes processing in a prediction loop and said processing includes said unbiased rounding of unsigned data and wherein the decoding includes processing in a prediction loop and said processing includes said unbiased rounding of unsigned data.

9. A method according to claim 7 or claim 8 wherein the data-compressed video is represented in frames and said unbiased rounding of unsigned data includes the unbiased rounding of inter-frame and/or intra-frame data.

10. Apparatus adapted to perform the methods of any one of claims 1, 2, 4, 5, 7 and 8.

11. A computer program, stored on a computer-readable medium for causing a computer to perform the methods of any one of claims 1, 2, 4, 5, 7 and 8.

12. A decoder for decoding a digital bitstream representing data-compressed video encoded at a first bit depth, comprising
means for receiving the digital bitsteam, and
means for decoding at a second, lower, bit depth, which means includes means for the unbiased rounding of unsigned data in intermediate processing.

13. A decoder according to claim 12 wherein said means for decoding includes means for processing in a prediction loop and said means for processing includes said means for the unbiased rounding of unsigned data.

14. A decoder according to claim 12 or claim 13 wherein the data-compressed video is represented in frames and said means for unbiased rounding of unsigned data includes means for the unbiased rounding of inter-frame and/or intra-frame data.

15. An encoder for encoding a digital bitstream representing data-compressed video, comprising
means for processing in a prediction loop, which processing includes the unbiased rounding of unsigned data in intermediate processing, and
means for outputting said digital bitstream.

16. An encoder according to claim 15 wherein said means for encoding includes means for processing in a prediction loop and said means for processing includes said means for the unbiased rounding of unsigned data.

17. An encoder according to claim 15 or claim 16 wherein the data-compressed video is represented in frames and said means for unbiased rounding of unsigned data includes means for the unbiased rounding of inter-frame and/or intra-frame data.

18. A system for encoding and decoding a digital bitstream representing data-compressed video, comprising
means for encoding at a first bit depth, said encoding including means for processing in a prediction loop, which means for processing includes means for the unbiased rounding of unsigned data in intermediate processing, and
means for decoding at a second, lower, bit depth, said means for decoding including means for processing in a prediction loop, which means for processing includes means for the unbiased rounding of unsigned data in intermediate processing.

19. A system according to claim 18 wherein the means for encoding includes means for processing in a prediction loop and said means for processing includes said unbiased rounding of unsigned data and wherein the decoding includes processing in a prediction loop and said processing includes said means for the unbiased rounding of unsigned data.

20. A system according to claim 18 or claim 19 wherein the data-compressed video is represented in frames and said means for unbiased rounding of unsigned data includes means for the unbiased rounding of inter-frame and/or intra-frame data.
